(19) United States
(12) Patent Application Publication
(10) Pub. No.: US 2003/0167295 A1
(43) Pub. Date: Sep. 4, 2003

(54) Automatic network load balancing using self-replicating resources

(75) Inventor: Kiam Choo, Mountain View, CA (US)

Correspondence Address: William L. Botjer, PO Box 478, Center Moriches, NY, 11934, US

(73) Assignee: Verity, Inc.

(21) Appl. No.: 10/087,055

(22) Filed: Mar. 1, 2002

(51) Int. Cl. G06F 15/173

(52) U.S. Cl. 709/104; 709/226

(57) ABSTRACT

The present invention provides a method, system and computer program to balance the computational and network load in networked computers using self-replicating programs, referred to as symbionts. The method presented here reduces hotspots by encapsulating a resource in a symbiont, and having a user access that symbiont through programs that host symbionts, referred to as hosts. When a host accesses a symbiont, it may replicate a copy of that symbiont resource on itself or may be redirected to some other replicate of the same symbiont. The host then offers the replicated resource on the network to alleviate the load experienced by the original symbiont's computer. If the load on a symbiont falls below a threshold, it is removed from the host on which it was hosted.

### BACKGROUND

1. Field of the Invention

The present invention relates to load balancing in a computer network, and deals more particularly with a method, system and computer program for load balancing of network traffic, computation and data resources through the use of replicating programs.

2. Description of the Related Art

Networked computer systems are rapidly growing as the means for storage and exchange of information. These days, a large number of resources are available on computer networks; these resources exist at the hardware, software and at networking levels. For example, at the hardware level, these resources usually include disk space, Random Access Memory, and computational power, whereas at the software level, these may include compilers and/or databases. One fundamental advantage of networking computers together is that one computer (or a user) can often access and use the resources of another. However, if a large number of users access any one of these resources simultaneously, there would be a sharp increase in network traffic, which in turn would result in the slowing down the entire network. Furthermore, if a resource is accessed from many computers at the same time, then such an overload may slow down the computer encapsulating that resource, to the extent of even essentially shutting it down. This would especially be true when the computer contains a very popular resource and when other computers access this resource frequently. When a computer or a node on a network thus becomes overloaded, it is commonly referred to as a “hot-spot”. Thus, a need arises to balance various loads on the network so that overloading of computers is avoided and the number of hot spots is reduced.

One method that addresses this problem deploys a powerful central server, that is, a server that has a powerful Central Processing Unit (CPU) and large memory space. However, confining distributed information to servers ignores the fact that substantial processing and storage power may be available on many smaller computers and these computers may constitute a majority of nodes in the network. Further, this method has a drawback in that the central server is incapable of meeting sudden upsurges in demands and the entire system is not easily scaleable. Finally, this has a major disadvantage in that this server may act as a single point of failure, and failure of this server may render the entire network essentially incapable of accessing all resources that reside on this computer. Therefore, there is a need to effectively balance the resources within a computer network in such a manner that the resources are easily and effectively accessed by all authorized users on the network, while at the same time ensuring that there is no hindrance to the performance and functioning of any computer on the network.

There exist various methods for reduction of hotspots on a network. In one such method, multiple servers may offer identical resources and the client may be connected to any of the multiple servers in order to satisfy the client's request. This method involves replication of popular resources (including data or computational services) on several other nodes of the network. However, this would typically involve an increase in hardware requirements and may even require additional servers. Further, the replication of resources from one server to another usually requires manual supervision. Moreover, this method is not dynamic in nature; indeed, if there is a sudden upsurge in demand, this method will not be able to replicate such resources automatically. Finally, in this method, even if a given resource is not accessed for a long time, it may still continue to consume precious storage space on the server or use its computational power.

Another widely used method for reducing hotspots is replication of data using “ftp mirrors”. The “File-Transfer-Protocol (ftp) mirroring” is generally used where the traffic is typically very high and the number of resources is very large. Examples of such networks include large Local Area Networks (LANs), Wide Area Networks (WANs), and of course, the Internet. For example, suppose there is a single server that is located in California, USA and it hosts MP3 files on the Internet. Clearly, such a server would be overloaded by requests from different locations of the world. Moreover, it would be more time consuming to access these resources from a distant location such as Singapore than a nearby location in the USA. Hence, in the ftp mirroring method, another server—that contains a “replicated image” of the first server—is deployed to minimize the traffic and reduce access time. However, even in this method, if there is a sudden increase in traffic, then one server does not have the capability to automatically replicate the resources, data and program of the other server (in order to reduce the load of the overloaded server). This is because ftp mirroring requires manual intervention to select “mirror servers” that are appropriate for replication and to select servers that are best suited to download data (by taking into account the incoming traffic and the proximity of server). In addition, it is worth noting that manual supervision is also required to setup these servers; this comprises installation of a server and uploading of resources. Hence the installation and maintenance of a server proves to be a cumbersome exercise. Moreover, when a resource is not in use for a long time, there is no provision to automatically erase it from server.

Various other methods exist in the literature that are related to load balancing. “Artificial Life Applied to Adaptive Information Agents” Spring Symposium on Information Gathering from Distributed, Heterogeneous Databases, AAAI Press, 1995 by Filippo Menczer, Richard K. Belew and Wolfram Willuhn describes a method that uses agents to retrieve information from a large, distributed collection of documents. When the agents obtain high quality results to their search queries, they replicate. This does not address the issue of load balancing in a network, and is primarily focused on retrieval of relevant documents. “Building Peer-to-Peer Systems With Chord, a Distributed Lookup Service” by Frank Dabek, Emma Brunskill, M. Frans Kaashoek, David Karger, Robert Morris, Ion Stoica and Hari Balakrishnan discloses a method of locating documents while placing few constraints on the applications that use it (http://pdos.lcs.mit.edu/chord). This addresses the issue of locating documents in a decentralized network that can be used as a basis for general-purpose peer-to-peer systems. Agoric systems use an economic paradigm to allocate distributed resources according to free market principles. The programs and computers in these systems become buyers and sellers of resources, much like a real-life marketplace and do not explicitly include replication. In consistent hashing, Freenet and other distributed hash systems, users of these systems have little or no control over the kind of data that may come and reside on their computers. These are more like file replication systems rather than systems meant for load balancing. All of these talk about either load balancing or file replication, but they do not discuss using file or program replication for load balancing.

In addition to the aforementioned means for load balancing, various patents have been granted during the last few years. These are discussed below.

U.S. Pat. No. 6,279,001 titled “Web Service”, and International Patent Application Nos. WO 98/57275 titled “Arrangement for Load Sharing in Computer Networks”, WO 00/28713 titled “Internet System and Method for Selecting a Closest Server from a Plurality of Alternative Servers” and WO 01/31445 titled “System and Method for Web Mirroring” disclose and describe selection of a mirror server based on certain heuristics such as availability of a resource, load on the server and geographical proximity of the server to the client. The mirror server has a replicated resource that may be a web page, one or more software programs, media files, or other such items. In all these inventions, the resource replication is performed manually. Replication in these inventions is not dynamic, i.e., even if a mirror server is not accessed very frequently, the replicated resource continues to reside on the same. Conversely, where the resource requirement witnesses an increase, the current methods do not have a provision for automatically replicating the resource onto an appropriate server since the replication is predetermined and it requires manual supervision. In other words, various heuristics given in these inventions do not contain any ‘birth’ and ‘death’ rules. Further, all these deal with replication of data only and not computational services.

International Patent Application No. WO 00/14634, titled “Load Balancing for Replicated Services”, deals with providing load balancing for replicated services or applications among a plurality of servers. A central server receives request for a service from a client and then directs it to the appropriate server, based upon its operational characteristics (such as its load and its proximity to the client). However, this invention does not undertake the actual replication of services; rather it deals with choosing the most appropriate server for a particular service request.

U.S. Pat. No. 5,963,944, titled “System and Method for Distributing and Indexing Computerized Documents Using Independent Agents”, uses autonomous agents to manage the distribution of data and to index information among the nodes of a computer network. Each network node includes a data storage device and an agent interface for execution of autonomous agents. The autonomous agents move independently among different network nodes and for each node they visit, they use the agent interface to execute their functions. However, this invention does not explicitly deal with replication of resources. It uses Balance Agents to break large files into smaller sub-files, and tries to alleviate any overload on any node in the network. Further, the load balancing mechanism is external to the resources i.e. the agents that manage replication are not embedded in the resources that are to be replicated.

Therefore, what is needed is a method and system for effectively balancing the load in a computer network by means of replication of resources, without the need for additional dedicated hardware. Indeed, such a replication should be dynamic, i.e. the resources should be automatically replicated depending upon its current demand; if the demand falls below a predetermined threshold, then such a replicated resource should be removed from the node onto which it had been originally copied. In other words, the replicated resource should ‘die’ so that various resources (such as computational power, storage space, networking ports and software) of a computer are not unnecessarily used up. Additionally, in order to avoid “single point failures,” it is desired that the replication of resources be decentralized.

### SUMMARY OF THE INVENTION

An object of the present invention is to provide a method, system and computer program for balancing computational and network loads in a network of computers using self-replicating programs.

Another object of the present invention is to provide a method, system and computer program to reduce the number of computers in a networked environment, that are under heavy usage.

Another object of the present invention is to provide a method, system and computer program that provides a solution for balancing either data or computational services resources, in a network of computers.

Another object of the present invention is to provide a method, system and computer program that manages the replication of a resource, when the need for that resource arises, in a fully automatic and dynamic way, in a network of computers.

Another object of the present invention is to provide a method, system and computer program that manages the deletion of a resource from a computer, when its need expires, in a fully automatic and dynamic way, in a network of computers.

Another object of the present invention is to provide a method, system and computer program that connects replicates of resources in a manner so as to minimize their frequent replication and deletion from the network of computers.

Still another object of the present invention is to provide a method, system and computer program that provides a self-replicating program (symbiont) that encapsulates the resource.

A further object of the present invention is to provide a method, system and computer program that provides a program (host) that provides a suitable living environment for symbionts to function and exposes the network's symbionts to applications on its computer.

Yet another object of the present invention is to provide a method, system and computer program that provides for genetic evolution of symbionts wherein each symbiont has a chromosome embedded in it.

To achieve the foregoing objects, and in accordance with the purpose of the present invention as broadly described herein, the present invention provides for a method, system and computer program to balance the computational and network load on networked computers using replicating programs. The invention reduces the hotspots by encapsulating a resource in a replicating program called a symbiont. When a host contacts a symbiont on behalf of an application, it may acquire and host a replicate of the resource. Further, when a host contacts a symbiont resource it may be redirected to another copy of the same resource. This redirection and replication, is done by the symbiont using the following algorithm: A host h contacts a symbiont s for a resource. If the symbiont encapsulating the resource is not “too busy”, it serves the request. If not, s checks out the load on its neighbors and if they are also “too busy”, s replicates the resources on to h. It also replicates the resource onto h if it has been redirected more than a predetermined number of times. In case, any of s's neighbors is not “too busy”, the one with less load serves the request. If h acquires a new symbiont, it joins the pool of available copies of the resource by letting some number of symbionts know about its existence. This is done so as to make sure that future requests to s are redirected to the symbiont on h. Finally, all the symbionts keep checking their own loads at regular “sufficiently large” time intervals. If they find that their load is below a threshold, they “die”.

The present invention will now be described with reference to the following drawings, in which like reference numbers denote the same elements throughout.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is a block diagram of a computer workstation environment in which the present invention may be practiced;

FIG. 2 is a diagram of a networked computing environment in which the present invention may be practiced;

FIG. 3 is a diagram showing replicates of a symbiont in a multiply-connected ring; and

FIG. 4 is a flowchart that illustrates the algorithm used by a symbiont when a host contacts it.

### DESCRIPTION OF PREFERRED EMBODIMENTS

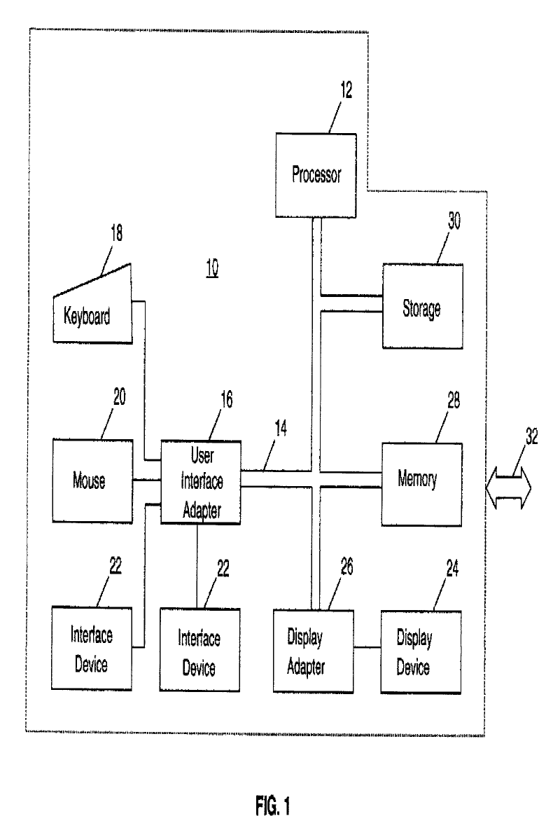

FIG. 1 illustrates a representative workstation hardware environment in which the present invention may be practiced. The environment of FIG. 1 comprises a representative single user computer workstation 10, such as a personal computer, including related peripheral devices. Workstation 10 includes a microprocessor 12 and a bus 14 employed to connect and enable communication between microprocessor 12 and the components of workstation 10 in accordance with known techniques. Workstation 10 typically includes a user interface adapter 16, which connects microprocessor 12 via bus 14 to one or more interface devices, such as a keyboard 18, mouse 20, and/or other interface devices 22, which can be any user interface device, such as a touch sensitive screen, digitized entry pad, etc. Bus 14 also connects a display device 24, such as an LCD screen or monitor, to microprocessor 12 via a display adapter 26. Bus 14 also connects microprocessor 12 to memory 28 and long-term storage 30 which can include a hard drive, diskette drive, tape drive, etc.

Workstation 10 communicates via a communications channel 32 with other computers or networks of computers. Workstation 10 may be associated with such other computers in a local area network (LAN) or a wide area network, or workstation 10 can be a client in a client/server arrangement with another computer, etc. All of these configurations, as well as the appropriate communications hardware and software, are known in the art.

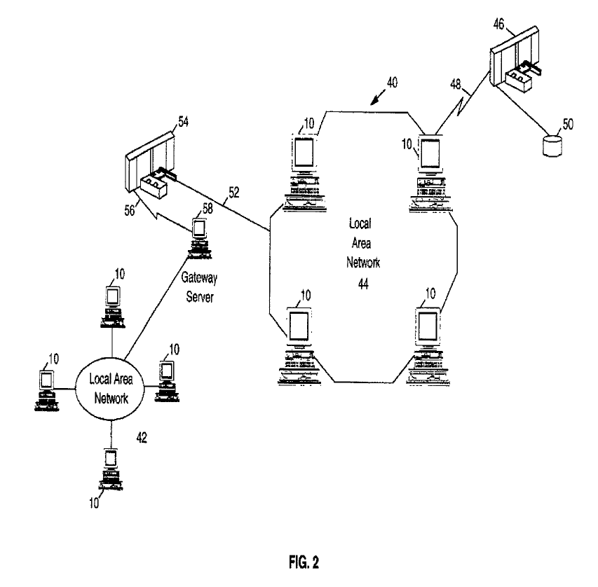

FIG. 2 illustrates a data processing network 40 in which the present invention may be practiced. Data processing network 40 includes a plurality of individual networks, including LANs 42 and 44, each of which includes a plurality of individual workstations 10. Alternatively, as those skilled in the art will appreciate, a LAN may comprise a plurality of intelligent workstations coupled to a host processor.

Still referring to FIG. 2, data processing network 40 may also include multiple mainframe computers, such as a mainframe computer 46, which may be preferably coupled to LAN 44 by means of a communications link 48.

Mainframe computer 46 may also be coupled to a storage device 50, which may serve as remote storage for LAN 44. Similarly, LAN 44 may be coupled to a communications link 52 through a subsystem control unit/communication controller 54 and a communications link 56 to a gateway server 58. Gateway server 58 is preferably an individual computer or intelligent workstation that serves to link LAN 42 to LAN 44.

Those skilled in the art will appreciate that mainframe computer 46 may be located a great geographic distance from LAN 44, and similarly, LAN 44 may be located a substantial distance from LAN 42.

Software programming code, which embodies the present invention, is typically accessed by microprocessor 12 of workstation 10 from long-term storage media 30 of some type, such as a CD-ROM drive or hard drive. In a client-server environment, such software programming code may be stored with storage associated with a server. The software programming code may be embodied on any of a variety of known media for use with a data processing system, such as a diskette, hard drive, or CD-ROM. The code may be distributed on such media, or may be distributed to users from the memory or storage of one computer system over a network of some type to other computer systems for use by users of such other systems. Alternatively, the programming code may be embodied in memory 28, and accessed by microprocessor 12 using bus 14. The techniques and methods for embodying software programming code in memory, on physical media, and/or distributing software code via networks are well known and will not be further discussed herein.

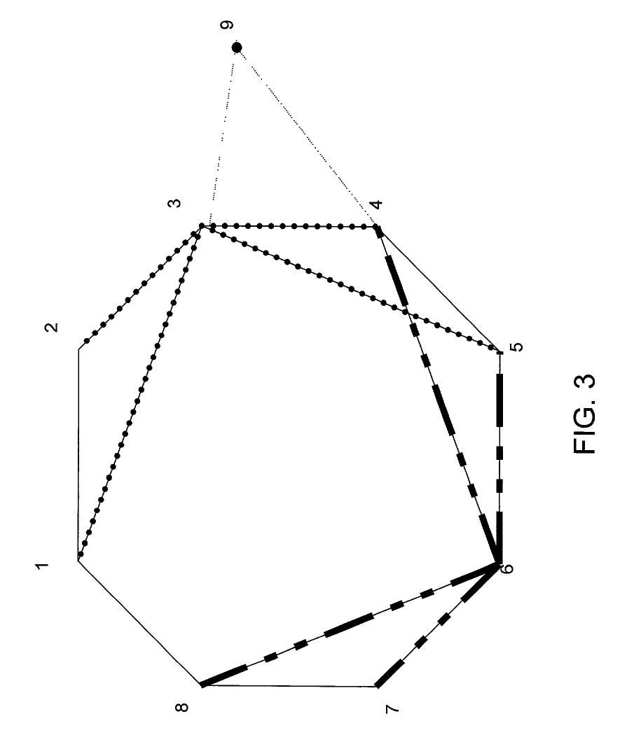

The preferred embodiments of the present invention will now be discussed with reference to FIGS. 3-5. In the preferred embodiments, the present invention is implemented as a computer software program. The software may execute on the user's computer or on a remote computer that may be connected to the user's computer through a LAN or a WAN that is part of a network owned or managed internally to the user's company, or the connection may be made through the Internet using an ISP. What is common to all applicable environments is that the user accesses a public network, such as the Internet, through his computer, thereby accessing the computer software that embodies the invention.

An embodiment of the present invention is hereinafter described in detail. The invention provides a method for balancing the computational and network load on networked computers using replicating programs. The invention balances resources that could be either data or computational services. A resource is something that on receiving a request from a host sends back a reply based on its current state. A data resource could be a database or a document or an article. A computational service could be a software program that runs on a computer.

The two essential software components in this invention are symbiont and host. A symbiont is a software program that replicates and dies based on certain birthing and death rules. These rules could either be hardwired into the system or could be specified when the system is being installed/used. These rules are formulated so that as soon as a computer on the network is overloaded (according to some threshold), the symbiont takes “birth” on another computer, to share this computer's load. Further, all symbionts keep checking loads on themselves at regular “long enough” time intervals, and if the symbiont experiences load less than some predetermined threshold, it “dies”. Moreover, the rules are such that there is not too much “churning” i.e. symbionts do not keep dying and taking birth at a high frequency. These rules could vary depending upon the embodiment of the present invention i.e. there could be several different rule based systems depending upon the embodiment used.

A host is a program that provides a suitable living environment for the symbiont to run i.e. it provides memory, storage, script interpretation, and other services necessary for the symbiont to function i.e. the symbiont runs within the host. In contrast, a symbiont is a self-replicating program that encapsulates a given resource and it does it in a manner that minimizes its frequent replication and deletion (from various computers in a given network).

The host may contain more than one symbiont. The host exposes its symbionts on the computer network as resources that others can use. It also exposes the network's symbiont resources to applications on its computer. It is through this host layer that applications connect to and send messages to symbiont resources on the network.

When the host contacts the symbiont on behalf of an application, it may acquire and host a copy (a replicate) of the resource. Further, when another host contacts the same symbiont resource, it may be redirected to this replicated copy of the same resource.

In the preferred embodiment of the present invention, all the replicates of a particular resource are arranged in the form of a multiply connected ring, by which we mean a graph whose vertices (labeled 0 through n-1) are arranged in a circle, with each vertex connected to m neighbors on either side, so that the replicates can communicate with each other. Let us assume that the ring has n replicates of a particular resource. Also, let us assume that each replicate is ‘connected’ to m other replicates on both sides (i.e. each node is connected to 2m other nodes) to make the entire design scaleable. If one says that two replicates are ‘connected’, it means that they can know each other's loads and other characteristics of the nodes. Consider the example network in FIG. 3. The figure illustrates a network with 8 nodes numbered 1 through 8. Each node, in turn is connected to two other nodes on each side. For example, node 6 is connected to nodes 8 and 7 on its left and nodes 4 and 5 on its right. Similarly, node 3 is connected to nodes 4 and 5 on its left and nodes 1 and 2 on its right. This way, each node can keep track of four other nodes. This information will be useful in case any of the nodes wants to redirect a request to any of its neighbors. Also, knowing the loads of only a certain number of neighbors makes the entire design scaleable.

Now let us consider a hypothetical situation wherein there is a ring of n nodes with each node connected to just one neighbor on each side. Let the load on the k'th replicate be Iₖ. Load here refers to the computational load on the node: the exact way in which it is to be represented depends on the implementation of the system. In first embodiment, the computational load is defined as the number of instructions per second that is executed by a given processor. In an alternate embodiment, the computational load may be defined as the number of requests that are handled by the processor; often, since the processor may take different amount of time to handle to different requests, yet another alternate embodiment may be used where each request has a weight associated with it (which corresponds to the time that will be taken by the processor to service it) and the computational load can be defined as the cumulative sum of the weighted requests that are handled by the processor in one second.

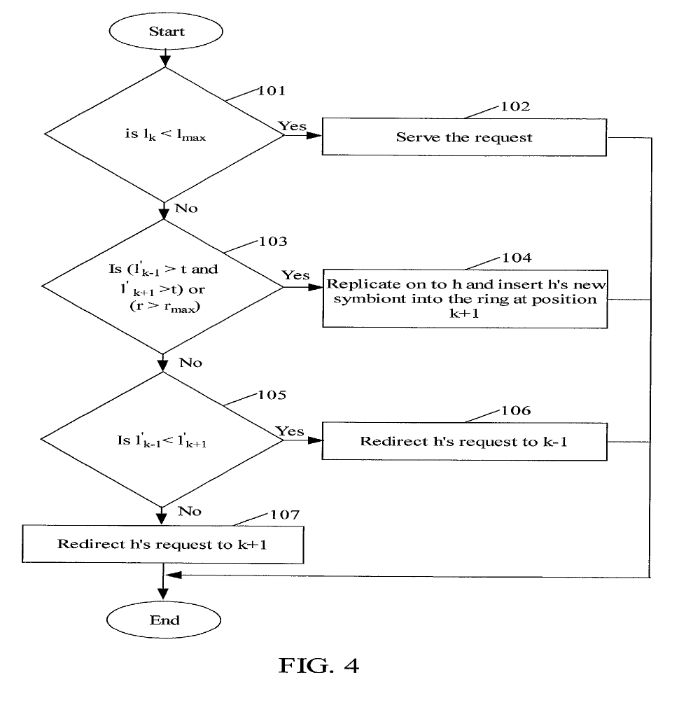

Connecting the replicates in the ring allows replicate k to acquire Iₖ₋₁ and Iₖ₊₁ at regular time intervals, which it stores as the last known loads I′ₖ₋₁ and I′ₖ₊₁ at k−1 and k+1. When a host h accesses replicate k, it specifies how many times r it has been redirected. k then runs the algorithm as illustrated as a flow chart in FIG. 4, as follows:

if Iₖ < Iₘₐₓ at 101 then

serve the request 102

else

if ((I′ₖ₋₁ > t and I′ₖ₊₁ > t) or r > rₘₐₓ at 103 then

replicate on to h and
insert h's new symbiont into the ring at position k+1 at 104.

else

if I′ₖ₋₁ < I′ₖ₊₁ at 105 then

redirect h's request to k−1 at 106

else

redirect h's request to k+1 at 107

end if

end if

end if

In the above, t≦Iₘₐₓ. In words, the algorithm does the following: when k's load exceeds the threshold Iₘₐₓ, it chooses between replicating the symbiont on h and redirecting h to one of its neighbors. If the last known loads on both k's left and right neighbors exceed the threshold t, it chooses to replicate symbiont onto h rather than burden its neighbors with an additional request. It also replicates symbiont onto h if h has already suffered from more than rₘₐₓ redirections. The new symbiont on h then joins the ring as k's left neighbor, i.e., at position k+1.

For services that are deemed essential, the reproductive threshold, Iₘₐₓ can be lowered so that its replicates become more abundant.

In addition to the above decision made by the symbiont, h ensures that, if it is redirected, subsequent requests are directed at the new target. Once a symbiont has been replicated onto h, it directs future requests at itself. Thus, the load on k is eased. Furthermore, workload has the tendency to diffuse out from busy areas of the ring.

Finally, at regular time intervals not triggered by requests, each symbiont checks its own loads. If it is below the threshold Iₘᵢₙ, it dies, i.e., it makes itself inoperable and ceases to exist, thereafter. This time interval must not be too short or it may lead to churning. Specifically, it should not be comparable to the time scale of the natural fluctuations in load seen by a symbiont. Moreover, one of the replicates of the resource can be encapsulated in a symbiont that is immortal i.e. it never dies. This is important so that even when all the replicates of a particular resource have died, at least one original copy remains. Further, the communication between the replicates can be improved by having some non-local connections between the replicates in the ring.

It is worth pointing out that in the preferred embodiment of the present invention, all replicates of a particular resource are arranged in the form of a multiply connected ring, i.e., a graph whose vertices (labeled 0 through n-1) are arranged in a circle, with each vertex connected to m neighbors on either side. In an alternative embodiment of the present invention, the replicates can be arranged in the form of a “tree.” In a tree, a one vertex (or a replicate) forms the root of the tree, this root is connected to several other vertices (called its children), and each of its children are, in turn, connected to several of their own children, and so on, until the “end children vertices” form the “leaves” of this tree. In yet another alternate embodiment, the vertices (or the replicates) may be all connected to each other, thereby, forming a “complete graph.” Indeed, it is easy to create other embodiments wherein the vertices (or the replicates) are connected to each other in any given, specified manner; such a specification is referred to as a simple graph (in Computer Science and the Mathematics' literature).

In another alternative embodiment of the present invention, the host in which the symbiont is residing can also perform some of the functions performed by the symbionts. For example, the host can perform the function of redirection that is presently encapsulated in the symbiont. As another example, the hosts may, for security reasons, have control over what is done by a symbiont that encapsulates a program. In that case, the “program” carried by the symbiont could be relegated to an integer that chooses between a few possible actions, each of which is actually implemented in the host although they might be thought of as computations that have been performed by the symbiont.

In another alternative embodiment of the present invention, genetic evolution of symbionts is possible wherein each symbiont has a “chromosome” embedded in it that is simply a piece of software code which is “distinctive” of that symbiont (just like a chromosome is distinctive of a living thing). The “chromosome” contains certain features of the symbiont that distinguish it from others. Moreover, these “chromosomes” decide the “superiority” of symbionts, i.e. symbionts with “better chromosomes” are considered better. This can be deduced from the access preference of hosts, as well as from the symbiont's performance. Using these “chromosomes”, and genetic operations like mutations and crossover, the system can come up with better quality symbionts. Further, if one needs to upgrade a symbiont, one just needs to introduce a higher version symbiont in the symbiont pool (with the heuristics that a higher version symbiont is a better one), so that it can be used from there on (only if it performs better than the previous versions!).

In another alternative embodiment of the present invention, the redirection is done on to the replicate that is “closest” (geographically or on the basis of some other user preferences) to the host that has requested for the resource.

In another alternative embodiment of the present invention, heavyweight resources may be broken up so that the smaller units can be run on different computers. A heavyweight resource is a file that is too large or a computation that is too intensive. In these cases, special non-birthing symbionts may be used, as hosts may refuse to host heavyweight symbionts. Also, the replication of data that is of a proprietary or sensitive nature needs to be carefully controlled.

While the preferred embodiment of the present has been described, additional variations and modifications in that embodiment may occur to those skilled in the art once they learn of the basic inventive concepts. Therefore, it is intended that the appended claims shall be construed to include both the preferred embodiment and all such variations and modifications as fall within the spirit and scope the invention.

What is claimed is:

1. A method for serving requests for resources by applications running on a computer, the computer being part of a network of computers, each computer on said network comprising a host program, each said host program comprising a symbiont, each said symbiont encapsulating one data processing resource, said method comprising the steps of:
a. said host receiving a request for said resource from an application running on said host's computer;
b. said host contacting said symbiont that encapsulates said resource; and
c. said symbiont either serving said request, or redirecting it to another replicate of itself, or replicating itself onto said host.

2. The method according to claim 1, wherein said host provides information relating to said symbionts available on said network to applications running on said host's computer.

3. The method according to claim 1, wherein said host provides information relating to said symbionts available on said host's computer to said network.

4. The method according to claim 1, wherein various replicates of said symbiont is connected together, to support a measure of communication among said replicates.

5. The method according to claim 4, wherein said various replicates of said symbiont are connected together in a multiply connected ring.

6. The method according to claim 1 or claim 4, wherein said step of said symbiont either serving said request, or redirecting it to another replicate of itself, or replicating itself onto said host, said step further comprising the steps of:
a. determining load on said symbiont, if load on said symbiont is less than its threshold, Iₘₐₓ, said symbiont serving said request;
b. determining load on said symbiont, if load on said symbiont is more than its threshold, Iₘₐₓ, and if load on all said connected replicates of said symbiont, is also more than their threshold, t, said symbiont replicating itself on said host;
c. determining load on said symbiont, if load on said symbiont is more than its threshold, Iₘₐₓ, and if said host has been redirected more than a predetermined number of times, said symbiont replicating itself on said host; and
d. determining load on said symbiont, if load on said symbiont is more than its threshold, Iₘₐₓ, and if at least one of said connected replicates of said symbiont, has a load less than their threshold, t, one of said connected replicates with load less than its threshold serving said request.

7. The method according to claim 6, wherein said threshold, Iₘₐₓ, of said symbiont, evolves with time according to some probabilistic measure.

8. The method according to claim 6, wherein said threshold, t, of said replicate of said symbiont is less than said threshold, Iₘₐₓ of said symbiont.

9. The method according to claim 6, wherein said threshold, t, of said replicate of said symbiont, evolves with time according to some probabilistic measure.

10. The method according to claim 6, wherein said step of one of said connected replicates with load less than its threshold serving said request, further comprises said replicate with least load serving said request.

11. The method according to claim 6, wherein said step of one of said connected replicates with load less than its threshold serving said request, further comprises said replicate closest to said host serving said request.

12. A system for serving requests for resources by applications running on a computer, the computer being part of a network of computers, each computer on said network comprising a host program, each said host comprising a symbiont, each said symbiont encapsulating one data processing resource, said system comprising:
a. means for said host receiving a request for said resource from an application running on said host's computer;
b. means for said host contacting said symbiont that encapsulates said resource; and
c. means for said symbiont handling said request.

13. The system according to claim 12, wherein said host provides information relating to said symbionts available on said network to applications running on said host's computer.

14. The system according to claim 12, wherein said host provides information relating to said symbionts available on said host's computer to said network.

15. The system according to claim 12, wherein said various replicates of said symbiont are connected together, to support some measure of communication among said replicates.

16. The system according to claim 15, wherein said various replicates of said symbiont are connected together in a multiply connected ring.

17. The system according to claim 12 or claim 15, wherein said means for said symbiont handling said request, further comprises:
a. means for said symbiont serving said request,
b. means for said symbiont replicating itself on said host,
c. means for one of said connected replicates with load less than its threshold serving said request.

18. The system according to claim 17, wherein said means for one of said connected replicates with load less than its threshold serving said request, further comprises means for said replicate with least load serving said request.

19. The system according to claim 17, wherein said means for one of said connected replicates with load less than its threshold serving said request, further comprises means for said replicate closest to said host serving said request.

20. A method for managing hosts and symbionts in a network of computers, each computer on said network comprising a host program, each said host program comprising a symbiont, each said symbiont encapsulating one data processing resource, said method comprising the steps of:
a. initializing a set of hosts and symbionts on said network;
b. adding a new symbiont for an existing resource to said network, whenever there is a need for one;
c. adding a new symbiont for a new resource to said network whenever said new resource is to be added; and
d. deleting said symbiont from said network of computers whenever certain conditions are met.

21. The method according to claim 20, wherein said host provides information relating to said symbionts available on said network to applications running on said host's computer.

22. The method according to claim 20, wherein said host provides information relating to said symbionts available on said host's computer to said network.

23. The method according to claim 20, wherein various replicates of said symbiont are connected together, to support some measure of communication among said replicates.

24. The method according to claim 23, wherein said various replicates of said symbiont are connected together in a multiply connected ring.

25. The method according to claim 20, wherein said initializing step further comprises the steps of:
a. initializing a host on each computer of said network;
b. encapsulating said resources that are to be initialized in one said symbiont each;
c. marking original copy of each of said symbiont encapsulating said resource, as immortal so that they are always present in said network; and
d. initializing said symbionts on computers in said network, wherein said symbiont runs in said host.

26. The method according to claim 25, wherein a symbiont run in said host.

27. The method according to claim 20 or claim 23, wherein said step of adding a new symbiont for an existing resource to said network, whenever there is a need for one, further comprises the steps of:
a. determining load on said symbiont, if load on said symbiont is more than its threshold, Iₘₐₓ, and if load on all said connected replicates of said symbiont, is also more than their threshold, t, said symbiont replicating itself on said host;
b. determining load on said symbiont, if load on said symbiont is more than its threshold, Iₘₐₓ, and if said host has been redirected more than a predetermined number of times, said symbiont replicating itself on said host; and
c. determining load on said symbiont, in either case, connecting said new symbiont to other said symbionts of said existing resource.

28. The method according to claim 27, wherein said threshold, Iₘₐₓ, of said symbiont, evolves with time according to some probabilistic measure.

29. The method according to claim 27, wherein said threshold, t, of said replicate of said symbiont is less than said threshold, Iₘₐₓ of said symbiont.

30. The method according to claim 27, wherein said threshold, t, of said replicate of said symbiont, evolves with time according to some probabilistic measure.

31. The method according to claim 20, wherein said step of adding a new symbiont for a new resource to said network whenever a new resource is to be added, further comprises the steps of:
a. encapsulating said new resource to be initialized in a new symbiont;
b. marking original copy of said new symbiont encapsulating said new resource, as immortal so that it is always present in said network; and
c. initializing said new symbiont on a computer in said network, wherein said new symbiont runs in said host.

32. The method according to claim 20, wherein said step of deleting said symbiont from said network of computers whenever certain conditions are met, further comprises the steps of:
a. said symbionts checking their loads at regular time intervals; and
b. said symbionts dying if their load is less than a threshold, Iₘᵢₙ.

33. The method according to claim 32, wherein said time intervals evolve with time.

34. The method according to claim 32, wherein said threshold, Iₘᵢₙ, evolves with time.

35. The method according to claim 32, wherein said symbionts marked immortal are never deleted from said network.

36. A system for managing hosts and symbionts in a network of computers, each computer on said network comprising a host, each said host comprising a symbiont, each said symbiont encapsulating one data processing resource, said system comprising:
a. means for initializing a set of hosts and symbionts on said network;
b. means for adding a new symbiont for an existing resource to said network;
c. means for adding a new symbiont for a new resource to said network; and
d. means for deleting said symbiont from said network of computers.

37. The system according to claim 36, wherein said host provides information relating to said symbionts available on said network to applications running on said host's computer.

38. The system according to claim 36, wherein said host provides information relating to said symbionts available on said host's computer to said network.

39. The system according to claim 36, wherein various replicates of said symbiont are connected together, to support some measure of communication among said replicates.

40. The system according to claim 39, wherein said various replicates of said symbiont are connected together in a multiply connected ring.

41. The system according to claim 36, wherein said initializing means further comprises:
a. means for initializing a host on each computer of said network;
b. means for encapsulating said resources that are to be initialized in one said symbiont each;
c. means for marking original copy of each of said symbiont encapsulating said resource, as immortal so that they are always present in said network; and
d. means for initializing said symbionts on computers in said network, wherein said symbiont runs in said host.

42. The system according to claim 41, wherein zero or more symbionts run in said host.

43. The system according to claim 36 or claim 39, wherein said means for adding a new symbiont for an existing resource to said network, whenever there is a need for one, further comprises:
a. means for said symbiont replicating itself on said host as a new symbiont; and
b. means for connecting said new symbiont to other said symbionts of said existing resource.

44. The system according to claim 36, wherein said means for adding a new symbiont for a new resource to said network whenever a new resource is to be added, further comprises:
a. means for encapsulating said new resource to be initialized in a new symbiont;
b. means for marking original copy of said new symbiont encapsulating said new resource, as immortal so that it is always present in said network; and
c. means for initializing said new symbiont on a computer in said network, wherein said new symbiont runs in said host.

45. The system according to claim 36, wherein said means for deleting said symbiont from said network of computers whenever certain conditions are met, further comprises:
a. means for said symbionts checking their loads at regular time intervals; and
b. means for said symbionts dying if their load is less than a threshold, Iₘᵢₙ.

46. The system according to claim 45, wherein said time intervals evolve with time.

47. The system according to claim 45, wherein said threshold, Iₘᵢₙ, evolves with time.

48. The system according to claim 45, wherein said symbionts marked immortal are never deleted from said network.
